(19) United States
(12) Patent Application Publication
(10) Pub. No.: US 2025/0158291 A1
(43) Pub. Date: May 15, 2025

(54) TRANSPARENT RF METASURFACE FOR 5G ANTENNAS

(71) Applicant: CORNING INCORPORATED, CORNING, NY (US)

(72) Inventors: Rocio Rodriguez Cano, Aalborg (DK); Igor Aleksandrovich Syrytsin, Horsens (DK); Shuai Zhang, Aalborg (DK)

(21) Appl. No.: 18/941,113

(22) Filed: Nov. 8, 2024

Related U.S. Application Data
(60) Provisional application No. 63/547,910, filed on Nov. 9, 2023.

(51) Int. Cl. H01Q 21/06; H01Q 1/38

(52) U.S. Cl. CPC H01Q 21/065; H01Q 1/38

(57) ABSTRACT

A communication device and method of forming the device are described. The device includes a mm Wave antenna on a substrate and glass cover protecting the substrate. A metasurface having a periodic set of unit cells is disposed on a surface of the substrate. A filter disposed between the unit cells has a sub-6 GHz passband. The metasurface has a structure that is designed to mitigate deleterious effects caused by the presence of the glass cover in close proximity to the mm Wave antenna.

### CROSS-REFERENCE TO RELATED APPLICATIONS

This application claims the benefit of priority under 35 U.S.C. § 119 of U.S. Provisional Application Ser. No. 63/547,910, filed on Nov. 9, 2023, the content of which is relied upon and incorporated herein by reference in its entirety.

### BACKGROUND

Mobile communication has evolved significantly from early voice systems to highly sophisticated integrated communication platform. The latest system that has been implemented, 5th generation (5G), as well as further generations are to provide access to information and sharing of data by various devices and applications. The next generation of devices use extended frequency bands, including Frequency range 1 (FR1) from 450 MHz to 6 GHZ (also called the sub-6 GHz range) and FR2 from 24.25 GHz to 52.6 GHZ (also called the mm Wave spectrum). The addition of the mm Wave bands increases the data rate, as well as reduces the latency, of communications. A number of issues that were less problematic for FR1 communications arise from the use of FR2. In particular, the shorter mmWave signals are more susceptible to being blocked or reflected by glass and other standard building materials, among others. This is problematic from the standpoint of sustaining communications in urban areas as well as between indoors and outdoors. In addition, the use of glass (especially low emissivity glass) may reduce the effectiveness of mm Wave signals.

### BRIEF DESCRIPTION OF THE FIGURES

The drawings illustrate generally, by way of example, but not by way of limitation, various aspects of the present invention.

FIG. 1 illustrates a block diagram of an example communication device.

FIG. 2 is a network diagram illustrating an example network environment, in accordance with some embodiments.

FIG. 3A illustrates a top view of an example patch antenna design.

FIG. 3B illustrates a side view of an example patch antenna design.

FIG. 4A illustrates a top view of an example radiation pattern without glass.

FIG. 4B illustrates a top view of an example radiation pattern with glass.

FIG. 4C illustrates a side view of an example radiation pattern without glass.

FIG. 4D illustrates a side view of an example radiation pattern with glass.

FIG. 5A illustrates a top view of an example solid metasurface unit cell.

FIG. 5B illustrates a top view of an example meshed conductor that forms a metasurface unit cell.

FIG. 5C illustrates a top view of an example low frequency filter.

FIG. 6A illustrates a side view of an example antenna design.

FIG. 6B illustrates a top view of an example antenna design.

FIG. 6C illustrates a top view of another example antenna design.

FIG. 6D illustrates an expanded view of a metasurface unit cell of the structure of FIG. 6C.

FIG. 6E illustrates an expanded view of a low frequency filter of the structure of FIG. 6C.

FIG. 6F illustrates calculated gain and S11 reflection coefficient for the antennas of FIGS. 6A-6E.

FIG. 7A illustrates an example electric field magnitude without a glass cover.

FIG. 7B illustrates an example electric field magnitude with a glass cover.

FIG. 7C illustrates an example electric field magnitude with a glass cover and a metasurface.

FIG. 8A illustrates an example radiation pattern without a glass cover.

FIG. 8B illustrates an example radiation pattern with a glass cover.

FIG. 8C illustrates an example radiation pattern with a glass cover and a metasurface.

FIG. 8D illustrates an example cumulative distribution function (CDF) vs threshold gain.

FIG. 9A illustrates an example measured gain in the boresight direction for different structures for the leftmost mmWave antenna of the array.

FIG. 9B illustrates an example measured gain in the boresight direction for different structures for the mmWave antenna next to the leftmost mm Wave antenna of the array.

FIG. 9C illustrates an example measured gain in the boresight direction for different structures for the mmWave antenna next to the rightmost mmWave antenna of the array.

FIG. 9D illustrates an example measured gain in the boresight direction for different structures for the rightmost mm Wave antenna of the array.

FIG. 10 is a flow diagram of an example method for providing a device that contains the metasurface.

FIG. 11 is a measured coverage Equivalent Isotropic Radiated Power (EIRP) cumulative distribution function (CDF) of an example mmWave antenna.

FIG. 12 is an example measured reflection coefficient of an LTE antenna.

FIG. 13 is an example measurement system.

FIGS. 14A-14D show an example of a manufactured prototype antenna structure.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Antennas referred to herein may comprise one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each antenna and the antennas of a transmitting station. In some MIMO embodiments, antennas may be separated by up to 1/10 of a wavelength or more.

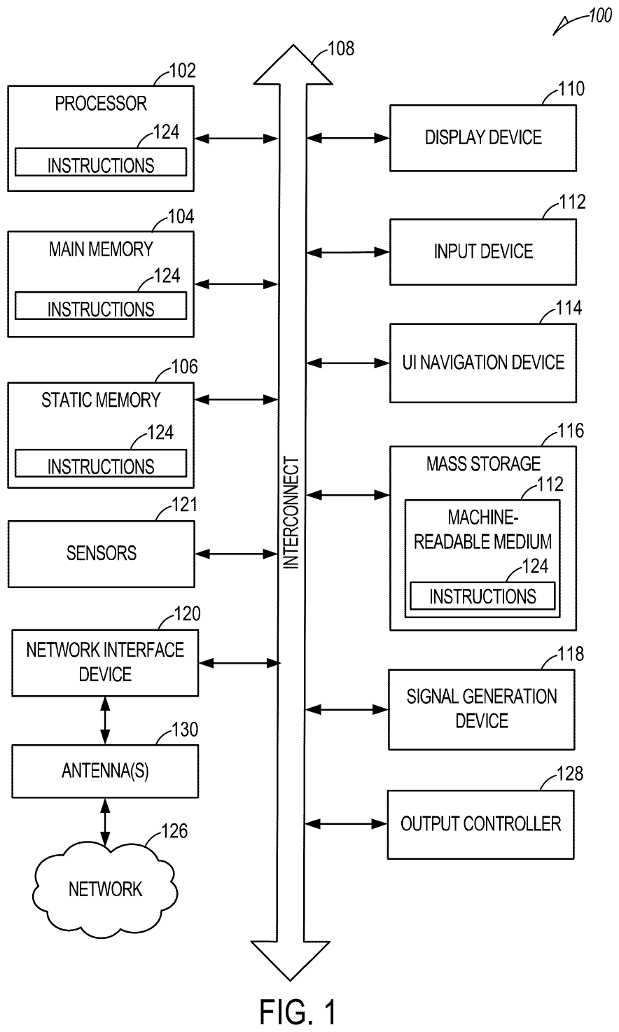

FIG. 1 illustrates a block diagram of an example communication device 100. In alternative embodiments, the communication device 100 may operate as a standalone device or may be connected (e.g., networked) to other communication devices. The communication device 100 may be a user equipment (UE) such as a portable communication device. A portable communication device may include a mobile phone, a smartphone, a laptop computer, a tablet computer, a web appliance, or any machine capable of executing instructions (sequential or otherwise) that specify actions to be taken by that machine that permit the machine to communicate over mmWave signals. The communication device 100 may have additional components not shown in FIG. 1 and/or some of the components shown in FIG. 1 may not be present.

The communication device 100 may include a hardware processor 102 (e.g., a central processing unit (CPU), a graphics processing unit (GPU), a hardware processor core, or any combination thereof), a main memory 104, and a static memory 106, some or all of which may communicate with each other via an interlink (e.g., bus) 108.

Specific examples of main memory 104 include Random Access Memory (RAM), and semiconductor memory devices, which may include, in some embodiments, storage locations in semiconductors such as registers. Specific examples of static memory 106 include non-volatile memory, such as semiconductor memory devices (e.g., Electrically Programmable Read-Only Memory (EPROM), Electrically Erasable Programmable Read-Only Memory (EEPROM)) and flash memory devices.

The communication device 100 may further include a display device 110, an input device 112 (e.g., a keyboard), and a user interface (UI) navigation device 114 (e.g., a mouse). In an example, the display device 110, the input device 112, and the UI navigation device 114 may be a touch screen display. The communication device 100 may additionally include a storage device (e.g., drive unit) 116, a signal generation device 118 (e.g., a speaker), a network interface device 120, one or more antennas 130, and one or more sensors 121, such as a global positioning system (GPS) sensor, compass, accelerometer, or other sensors. The communication device 100 may include an output controller 128, such as a serial bus (e.g., universal serial bus (USB)), parallel, or other wired or wireless (e.g., infrared (IR), near field communication (NFC), etc.) connection to communicate or control one or more peripheral devices (e.g., a printer, card reader, television). In some embodiments, the hardware processor 102 and/or instructions 124 may comprise processing circuitry and/or transceiver circuitry.

The storage device 116 may include a machine-readable medium 122 on which is stored one or more sets of data structures or instructions 124 (e.g., software) embodying or utilized by any one or more of the techniques or functions described herein. The instructions 124 may also reside, completely or at least partially, within the main memory 104, within static memory 106, or the hardware processor 102 during execution thereof by the communication device 100. In an example, one or any combination of the hardware processor 102, the main memory 104, the static memory 106, or the storage device 116 may constitute machine-readable media.

While the machine-readable medium 122 is illustrated as a single medium, the term “machine-readable medium” may include a single medium or multiple media (e.g., a centralized or distributed database, and/or associated caches and servers) configured to store instructions 124. The term “machine-readable medium” may include any medium that is capable of storing, encoding, or carrying instructions for execution by communication device 100 and that causes the communication device 100 to perform any one or more of the techniques of the present disclosure, or that is capable of storing, encoding or carrying data structures used by or associated with such instructions. Non-limiting machine-readable medium examples may include solid-state memories and optical and magnetic media. Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

The instructions 124 may further be transmitted or received over a communications network 126 using a transmission medium via the network interface device 120 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, 3GPP family of standards including Long Term Evolution (LTE) and 4G/5G/6G standards, a Universal Mobile Telecommunications System (UMTS) family of standards, peer-to-peer (P2P) networks, among others.

In an example, the network interface device 120 may include one or more physical jacks (e.g., Ethernet, coaxial, or phone jacks) or one or more antennas to connect to the communications network 126. In an example, the network interface device 120 may include one or more antennas 130 to wirelessly communicate using at least one of single-input multiple-output (SIMO), multiple-input multiple-output (MIMO), or multiple-input single-output (MISO) techniques. In some examples, the network interface device 120 may wirelessly communicate using Multiple User MIMO techniques. The term “transmission medium” shall be taken to include any intangible medium that is capable of carrying instructions for execution by the communication device 100, which include digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to ROM, RAM, magnetic disk storage media, optical storage media, flash memory, etc.

The hardware processor 102 may use various circuitry to send and receive communication via the antennas 130. Although not exclusive, such circuitry may include mixers (such as up- and down-conversion mixer circuitry configured to convert signals between baseband and the transmission frequency), amplifiers configured to amplify signals for communication, filters configured to filter out spurious signals, and drivers to drive the antennas 130.

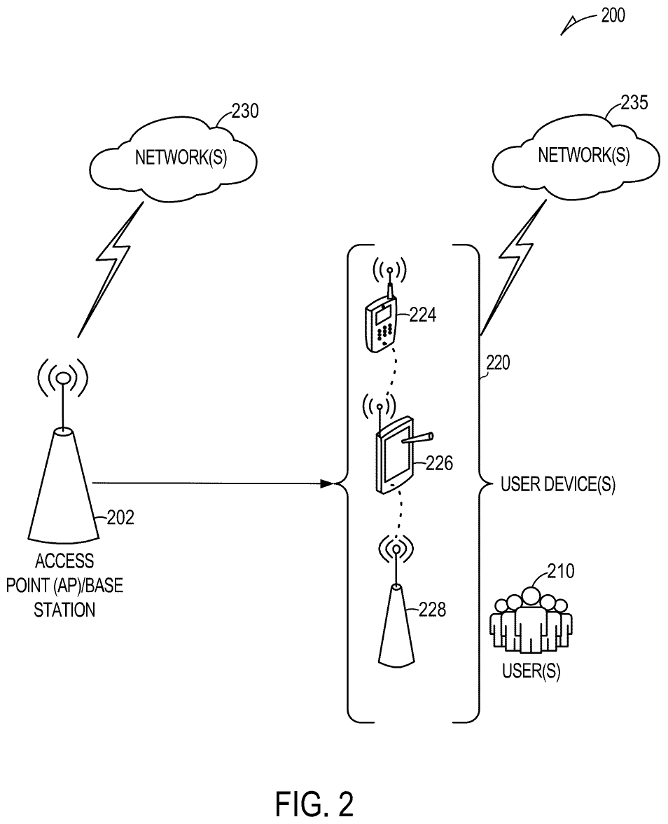

FIG. 2 is a network diagram illustrating an example network environment, in accordance with some embodiments. Wireless network 200 may include one or more user devices 220 and at least one access point (AP) 202 (or base station, such as an evolved NodeB (cNB)), which may communicate in accordance with any of the communication standards herein. The one or more user devices 220 may be mobile devices that are non-stationary (e.g., not having fixed locations) or may be stationary devices. In some embodiments, the one or more user devices 220 and the at least one AP 202 may include one or more computer systems similar to that of the functional diagram of other figures shown herein.

The one or more user devices 220 and/or at least one AP 202 may be operable by one or more users 210. The one or more user device 220 and/or the at least one AP 202 may also include mesh stations in, for example, a mesh network, in accordance with one or more IEEE 802.11 standards and/or 3GPP standards.

Any of the one or more user devices 220 (e.g., user devices 224, 226, 228) and the at least one AP 202 may be configured to communicate with each other via one or more communications networks 230 and/or 235, which can be wireless or wired networks. The one or more user devices 220 may also communicate peer-to-peer or directly with each other with or without the at least one AP 202. Any of the one or more communications networks 230 and/or 235 may include but is not limited to, any one of a combination of different types of suitable communications networks such as broadcasting networks, cable networks, public networks (e.g., the Internet), private networks, wireless networks, cellular networks, or any other suitable private and/or public networks.

Any of the one or more user devices 220 (e.g., user devices 224, 226, 228) and the at least one AP 202 may include one or more communications antennas. The one or more communications antennas may be any suitable type of antenna corresponding to the communications protocols used by the one or more user devices 220 (e.g., user devices 224, 226, 228), and the at least one AP 202. Some non-limiting examples of suitable communications antennas include Wi-Fi antennas, 3GPP standard compatible antennas, the IEEE 802.11 family of standards compatible antennas, directional antennas, non-directional antennas, dipole antennas, folded dipole antennas, patch antennas, MIMO antennas, omnidirectional antennas, quasi-omnidirectional antennas, or the like. The one or more communications antennas may be communicatively coupled to a radio component to transmit and/or receive signals, such as communications signals to and/or from the one or more user devices 220 and/or the at least one AP 202.

Any of the one or more user devices 220 (e.g., user devices 224, 226, 228) and the at least one AP 202 may be configured to perform directional transmission and/or directional reception in conjunction with wirelessly communicating in a wireless network. Any of the one or more user devices 220 (e.g., user devices 224, 226, 228) and the at least one AP 202 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the one or more user devices 220 (e.g., user devices 224, 226, 228), and the at least one AP 202 may be configured to perform any given directional transmission towards one or more defined transmit sectors. Any of the one or more user devices 220 (e.g., user devices 224, 226, 228) and the at least one AP 202 may be configured to perform any given directional reception from one or more defined receive sectors.

MIMO beamforming in a wireless network may be accomplished using RF beamforming and/or digital beamforming. In some embodiments, in performing a given MIMO transmission, any of the one or more user devices 220 (e.g., user devices 224, 226, 228) and the at least one AP 202 may be configured to use all or a subset of its one or more communications antennas to perform MIMO beamforming.

Any of the one or more user devices 220 (e.g., user devices 224, 226, 228) and the at least one AP 202 may include any suitable radio and/or transceiver for transmitting and/or receiving RF signals in the bandwidth and/or channels corresponding to the communications protocols utilized by any of the one or more user devices 220 and the at least one AP 202 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the IEEE 802.11 standards. In certain example embodiments, the radio component, in cooperation with the communications antennas, may be configured to communicate via 2.4 GHz channels (e.g. 802.11b, 802.11 g, 802.11n, 802.11ax), 5 GHZ channels (e.g. 802.11n, 802.11ac, 802.11ax), or 20 GHz channels (e.g. 802.11ad, 802.11ay), or 700 MHz channels (e.g. 802.11ah)—any channels in FR1 and FR2. The communications antennas may operate at 28 GHz and 40 GHz. It should be understood that this list of communication channels is only a partial list. In some embodiments, non-Wi-Fi or 3GPP protocols may be used for communications between devices, such as Bluetooth, dedicated short-range communication (DSRC), Ultra-High Frequency (UHF) (e.g. IEEE 802.11af, IEEE 702.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In mmWave technology, communications between devices may use associated effective wireless channels that are highly directionally dependent. To accommodate the directionality, beamforming techniques may be utilized to radiate energy in a certain direction with a certain beam width to communicate between two devices. The directed propagation concentrates transmitted energy toward a target device to compensate for significant energy loss in the channel between the two communicating devices. Using directed transmission may extend the range of the millimeter-wave communication versus utilizing the same transmitted energy in omnidirectional propagation.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. Considering examples in which modules are temporarily configured, each of the modules may not be instantiated at any one moment in time. For example, where the modules comprise a general-purpose hardware processor configured using the software, the general-purpose hardware processor may be configured as respective different modules at different times.

Some embodiments may be implemented partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; flash memory, etc.

As above, devices shown above that communicate using mm Wave bands may have difficulties communicating in particular environments, such as urban or indoors. In addition to materials in the external environment blocking or deteriorating the mm Wave signal however, a relatively large amount of glass such as glass cover and/or other dielectric materials may be incorporated in a number of devices (e.g., smartphones). While in some cases the mm Wave antenna may be formed along the edge of a smartphone or at the back of a printed circuit board (PCB) stack more proximate to the user, the mmWave antenna may be located in other locations or may radiate towards the glass cover. That is, the mm Wave antenna of smartphones or other devices may be disposed by design near the glass cover, thereby detrimentally affecting the performance of the mmWave antenna (including electric field, radiation pattern, and antenna gain).

The structure herein may be used with an mmWave antenna to improve the mmWave antenna performance in the presence of a superstrate, such as a glass cover in a smartphone (which covers the face of the smartphone). In particular, a metasurface may be deposited on the superstrate to enhance antenna gain and reduce gain ripple caused by the presence of the glass cover. The metasurface may be essentially a two-dimensional structure (also referred to as a patch structure) and thus may have an overall thickness that is below the wavelength used for communication by the mm Wave antenna. As used herein, the term “substantially two-dimensional” or “two-dimensional” refers to a structure having a thickness that is less than a resonance frequency associated with a mmWave antenna.

The metasurface may be deposited on the glass cover or other dielectric substrate that protects the mmWave antenna. The metasurface may be formed, in some aspects, using meshed conductive materials. The conductor may be formed from one or more materials, such as a Transparent Conductive Oxide (TCO) (such as Indium Tin Oxide (ITO) or Zinc Oxide (ZnO)) or an opaque metal, such as copper or aluminum. In either case, the metasurface may be relatively thin (e.g., less than about 10% of the thickness of the glass cover) and/or may take up a relatively small area (up to about few percent of the size of the glass cover), making the metasurface either transparent (or substantially transparent) or generally not noticeable on the glass surface. The metasurface in either case thus may be formed from one or more opaque conductive materials and/or substantially transparent conductive materials. The term “substantially transparent” is used here to indicate about 90% to about 99.9% transparency (average transmittance) over a wavelength range from about 400 nm to about 800 nm. The design of metasurface, as indicated herein, is insensitive to shifts with respect to antenna position, mitigating or eliminating alignment issues of the metasurface with respect to the mmWave antenna. The combination of the antenna and the metasurface (and supporting structures) may be defined as a combined antenna structure.

In some aspects, the metasurface may be formed in unit cells, similar to the mmWave antenna. The unit cells of the metasurface may be coupled together using filters. The filters may be planar filters deposited at the same time as the metasurface using the same materials and processes and that are substantially identical in thickness as the unit cells. Alternatively, the filters may be discrete components (if small enough to have limited visibility) and/or traces formed on a different layer as the metasurface. The use of planar filters at the edge of the metasurface unit cell allows for a passband at a particular frequency, e.g., at the sub-6 GHz frequency range (FR1), at which LTE or 4G antennas operate. The use of the filter may limit negative effects of the metasurface on the performance of nearby low-frequency antennas in the device.

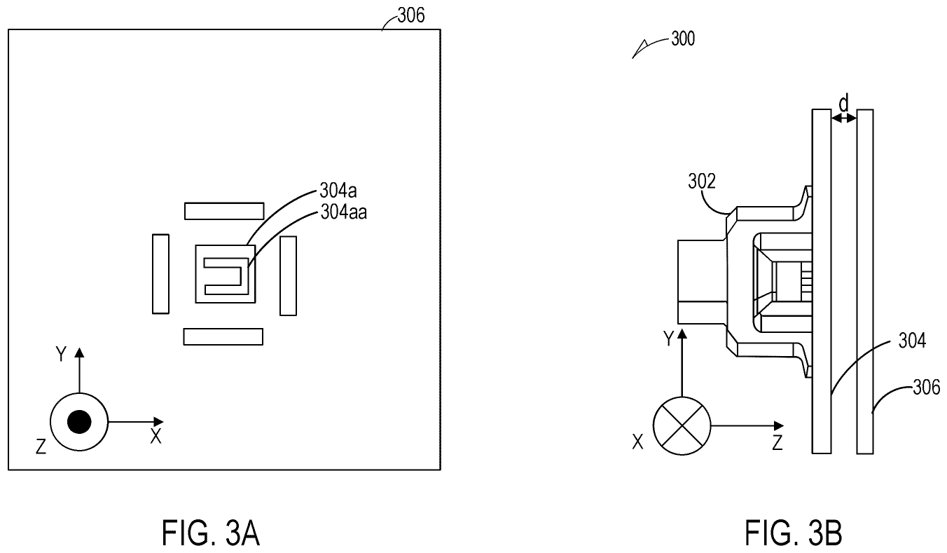

An example patch antenna design is shown in FIGS. 3A and 3B, in which FIG. 3A illustrates a top view of an example patch antenna design and FIG. 3B illustrates a side view of an example patch antenna design. The antenna design 300 includes a substrate 304 that contains a patch mmWave antenna 304a disposed thereon, and a glass cover 306 separated from the substrate 304 and mmWave antenna 304a by a predetermined distance d. The glass cover 306 may be disposed close enough to the mmWave antenna 304a to cause significant detrimental distortions in the electric field and gain of the mmWave antenna 304a. The separation between the substrate 304 and the glass cover 306 may be about 0.7 mm, for example. This distance may be decided by the device (e.g., phone) manufacturer, and may be from about 0.4 mm to about 1 mm for a smartphone. In aspects, the mm Wave antenna 304a can be incorporated into an antenna array with a plurality of other antenna designs. For example, the mm Wave antenna 304a shown in FIGS. 3A-3B may be used for each mmWave antenna of the 1×4 mmWave antenna array described below.

The substrate 304 may be supported by a mechanical support 302 and through which signals are communicated between the mmWave antenna 304a and processing circuitry. The mm Wave antenna 304a may have a main portion 304aa and side portions 304ba. The main portion 304aa has a predetermined radiative pattern 304aaa formed therein. The mm Wave antenna 304a may be, for example, a patch antenna that is formed by deposition and etching of one or more conductive layers. Typical dimensions of the mmWave antenna 304a include a center conductive rectangle (depicted as the main portion 304aa in FIG. 3A) of about 2.1 mm×2.4 mm, with an internal pattern (depicted as the radiative pattern 304aaa in FIG. 3A) having a length of about 1.8 mm and width of about 1.3 mm (internal cutouts having horizontal openings in the x-direction about 0.36 mm wide separated by about 0.6 mm in the y-direction, with the horizontal openings being connected to one another at ends thereof by a vertical opening in the y-direction). The center conductive rectangle may be encircled by edge conductors formed as rectangles (depicted as the side portions 304ba in FIG. 3A). The edge conductors may be longer than the center conductive rectangle (e.g., about 2.6 mm compared to the 2.4 mm length of the center conductive rectangle), have a thickness of about 0.5 mm, and may be separated from the center conductive rectangle by about half of the length of the center conductive rectangle (e.g., about 0.92 mm). Note that the mmWave antenna design shown in FIG. 3A and values indicated are merely exemplary; variations may be used to obtain a desired radiation pattern at a particular frequency of interest. In some aspects, the mmWave antenna 304a may be formed from a single cell as shown, in other aspects, the mmWave antenna 304a may be formed from multiple cells.

The substrate 304 may be formed from any suitable material to support the mmWave antenna 304a such as a dielectric layer, polymer, silica, ceramic, or a combination thereof (e.g., FR4), among others. The glass cover 306 may be formed from a silicate glass, borosilicate glass, aluminosilicate glass, aluminoborosilicate glass, soda lime glass, Gorilla™ Glass (an alkali-metal alumino-silicate glass toughened by ion exchange of potassium for sodium), or a combination thereof, among others. In embodiments, the glass cover 306 can have a thickness in a range from 100 μm to 5.0 mm (e.g., from 0.3 mm to 1.5 mm, from 0.4 to 1.3 mm, from 0.5 mm to 1.1 mm). In some embodiments, the substrate 304 and glass cover 306 may have about the same thickness, e.g., typical thicknesses of about 0.76 mm and about 0.65 mm, respectively. The glass cover 306 may form a window of a smartphone or other device, for example.

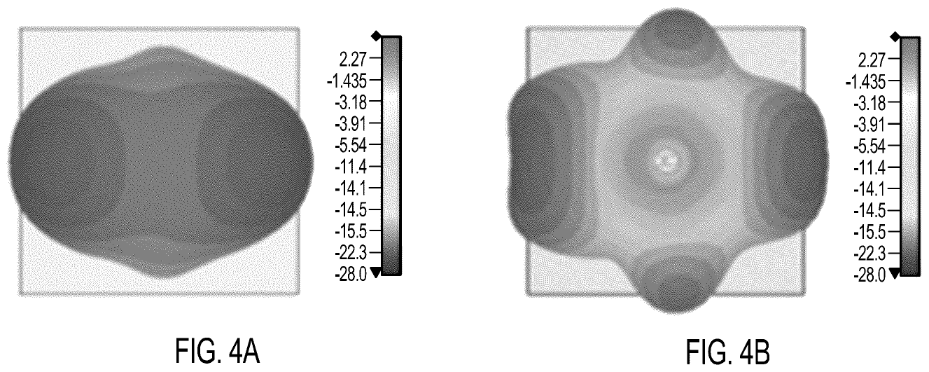

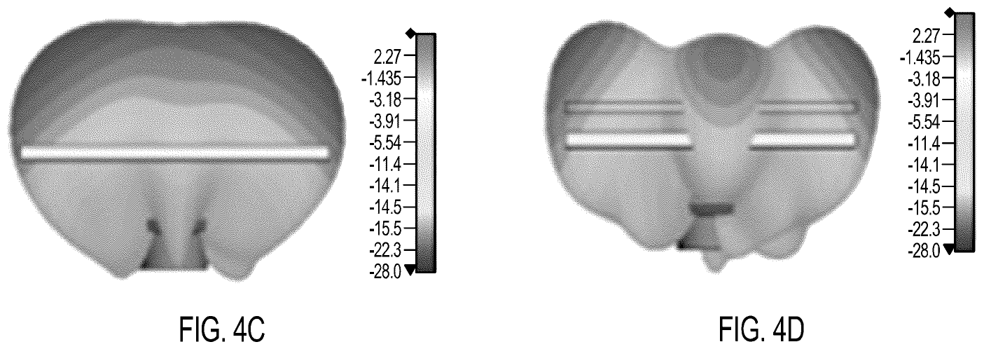

FIGS. 4A-4D show radiation patterns of the mmWave antenna shown in FIGS. 3A-3B in which FIG. 4A illustrates a top view of an example radiation pattern without glass, FIG. 4B illustrates a top view of an example radiation pattern with glass, FIG. 4C illustrates a side view of an example radiation pattern without glass, and FIG. 4D illustrates a side view of an example radiation pattern with glass. The antenna gain in FIGS. 4B-4D is shown in dBi at 26 GHz for a glass thickness of about 0.65 mm. The separation between the substrate 304 and the glass cover 306 may be about 0.7 mm, for example. As is apparent, the radiation pattern of the mmWave antenna is severely distorted by the presence of the glass, and the gain of the mmWave antenna is reduced.

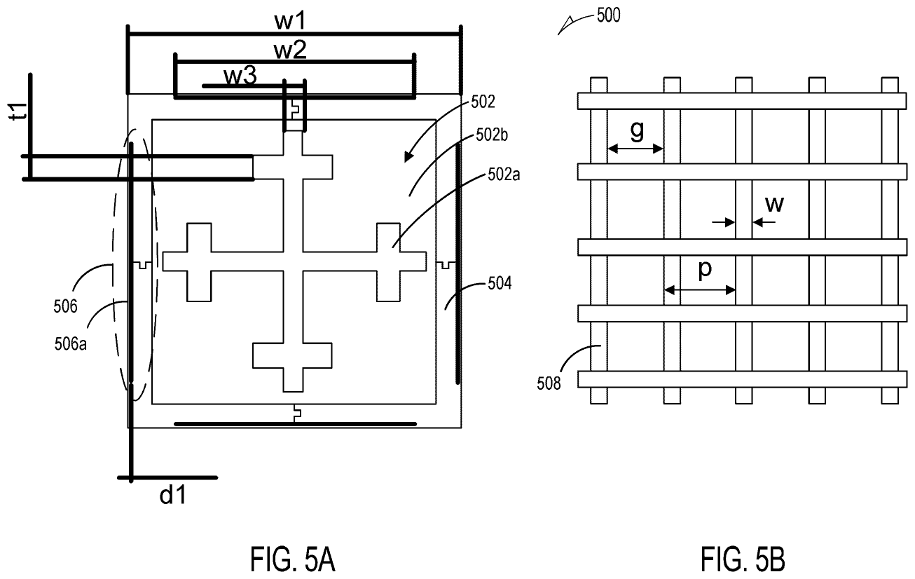

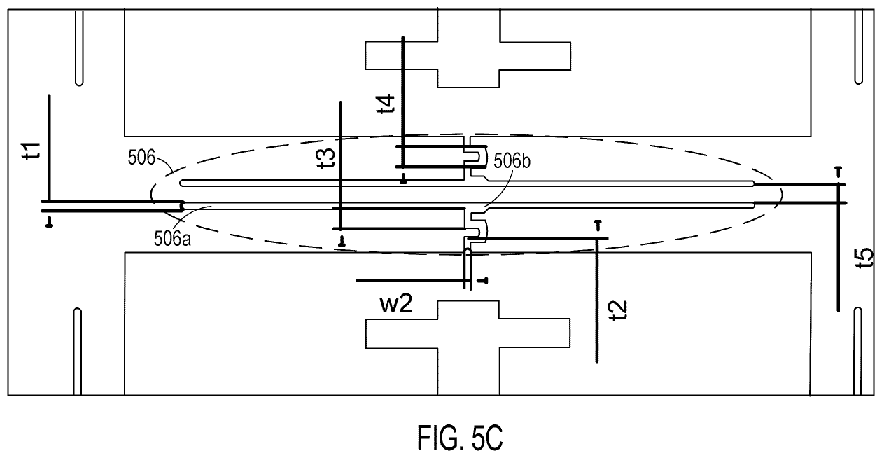

FIGS. 5A-5C show details of the metasurface. In particular, FIG. 5A illustrates a top view of an example solid metasurface unit cell, FIG. 5B illustrates a top view of an example meshed conductor used in a metasurface unit cell, and FIG. 5C illustrates a top view of an example low frequency filter. The metasurface 500 may be used to reduce the effect of glass on the radiation pattern and gain of an antenna, no matter which broadside-radiating antenna is placed below. The metasurface unit cell 500 may include a substrate 504 on which the metasurface 502 is formed. The metasurface 502 of adjacent metasurface unit cells 500 may be coupled together using filter 506. The filter 506 may be an RC filter whose harmonic frequency is tuned to the low frequency band (sub-6 GHZ). The metasurface 502 may be significantly smaller (e.g., by a factor of greater than about 100 times) thinner than the substrate 504 on which the metasurface 502 is formed and thus be substantially two dimensional. In some examples, the thickness of the metasurface 502 may be from about 600 nm to about 1800 nm.

The substrate 504 may be formed from one or more dielectric layers such as those above, while the metasurface 502 may be formed one or more conductors, such as an opaque metal (e.g., copper or aluminum) or TCO. The metasurface 502 may be, as shown in FIG. 5A, formed from a main area 502b with a cutout 502a. The main area 502b of the metasurface 502 may be formed from a solid conductor as shown in FIG. 5A. The cutout 502a may be removed from the main area 502b and formed in substantially a plus sign whose legs end in another plus sign (or cross), although other shapes may be used.

In one example of the dimensions in FIG. 5A, the width of the metasurface unit cell 500 (w1) may be about 2.8 mm and the width of the cutout 502a (w2) may be about 2.0 mm. Within the cutout 502a, the width of the legs of the main plus sign (w3) may be about 0.16 mm and the thickness of the secondary plus signs (t1) at the end of the legs may be about the same or slightly thicker at about 0.2 mm. The thickness (d1) of one plate of a parallel plate capacitor 506a of the filter 506 at the edge of the metasurface unit cell 500 may be about 0.02 mm. Modeled results using these values indicate that the big inner slot of the cutout 502a resonates at 26 GHZ, with a low E-field magnitude, while the outer small cross slot resonators become excited at 28 GHz. In other examples, the proportions of the various dimensions may be kept the same but may be scaled to modify the operating frequency. The size of unit cell dictates the two resonances at the high band (mm Wave). The length of capacitor described herein may affect one of the resonances as well, however the cut-off frequency for the low frequency (LTE sub-6 GHZ) may be affected less.

While FIG. 5A shows a metasurface 502 that is solid (other than the cutout 502a), in other aspects, the metasurface 502 may be formed from a conductive mesh 508 (or lattice) as shown in FIG. 5B. FIG. 5B illustrates the pitch (p) of the mesh 508 may be equal to the width (w) of the individual strands of the mesh 508 plus the gap (g) between the individual strands of the mesh 508. The mesh 508 may form gaps that have a regular square pattern. The use of a mesh 508, if formed from an opaque (non-TCO) conductor, may help to ensure that the metasurface 502 is substantially transparent on the underlying substrate 504. In the meshed structure shown in FIG. 5B, the electrical and optical properties depend on parameters such as mesh shape, line width, gap, pitch, and conductor thickness.

$$T = 0 \text{.96} \times {( \frac{p - s}{p} )}^{2}$$

In one example, the copper line width is w=15 μm, the gap is g=150 μm, and the copper thickness is 0.5 μm, giving an optical transparency (for an opaque conductor) of about 79%. In other designs, the width may range between about 3 μm and about 7 μm to achieve improved optical transparency while providing acceptable response. In general, the parameters of the mesh 508 (p, g, w) can be selected so as to achieve a suitable transmission value (e.g., an optical transparency of greater than or equal to 75%).

FIG. 5C includes an enhanced view of the filter 506 shown in FIG. 5A, showing the edges of adjacent metasurface unit cells 500. In addition to the parallel plate capacitor 506a (capacitive portion) of the filter 506, the resistive (inductive) portion 506b of the filter 506 is shown. The length of the parallel plate capacitor 506a (and/or distance between plates of the parallel plate capacitor 506a) and/or the length of resistive portion 506b of the filter 506 may be tuned to a sub-6 GHz frequency as a passband. The length of resistive portion 506b includes the number of windings from the edge of the metasurface 502 to the parallel plate capacitor 506a as well as the distance from the top to the bottom of one of the windings of the resistive portion 506b (in the width direction).

In one example of the dimensions in FIG. 5C, the width of the resistive portion 506b (w2) may be about 0.02 mm. The distance (t2) between the edge of the metasurface 502 and the first winding of the resistive portion 506b may be about 0.05 mm. The distance (t3) between the windings of the resistive portion 506b and the distance (t4) between the last winding of the resistive portion 506b and the parallel plate capacitor 506a may be about equal, e.g., about 0.07 mm. In other aspects, the latter two distances (t3, t4) may be different from each other. The distance (15) between the plates of the parallel plate capacitor 506a may be about 0.06 mm.

Thus, the metasurface unit cell 500 may have a magnetic resonators of different shape. The resonant frequency of the metasurface unit cell 500 is adjusted by modifying the widths and lengths of the slots and the stub position in the smaller inner slot in FIG. 5A. The thin slot in a copper layer forming the metasurface unit cell 500 between unit cells creates a pass band at the sub-6 GHz frequency where LTE antennas operate using a filter formed by two copper strips and two meander line inductors added to the edge of the structure as shown in FIG. 5C. The filter operates as a short circuit at mm-wave frequencies and as an open circuit at sub-6 GHZ (LTE) frequencies. In some aspects, an array of about ten unit cells may be used.

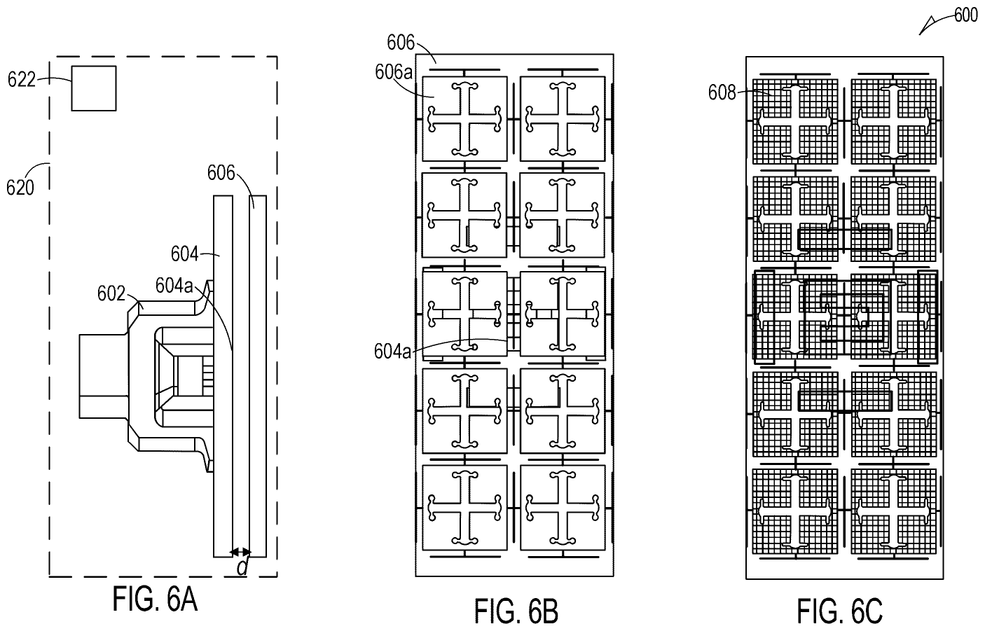

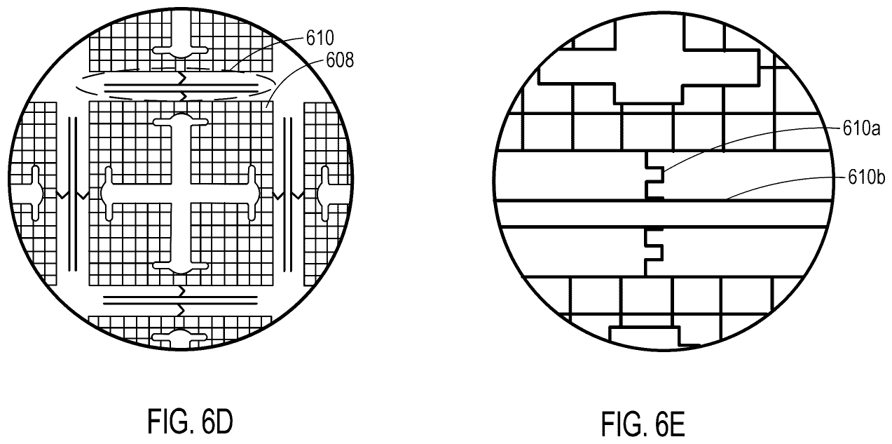

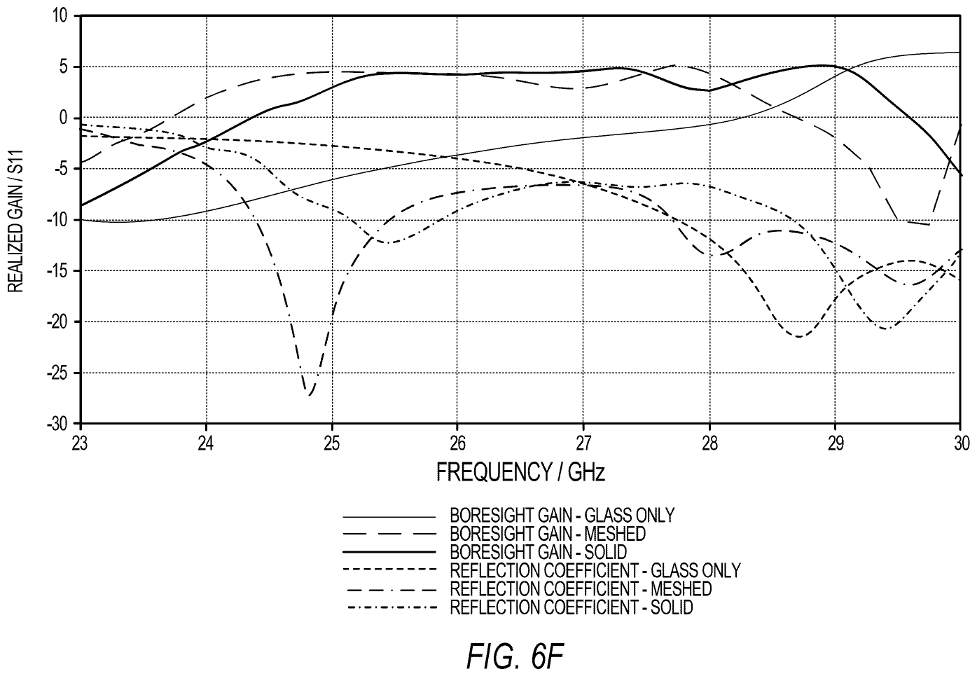

Various views of the antenna design are shown in FIGS. 6A-6E in which FIG. 6A illustrates a side view of an example antenna design, FIG. 6B illustrates a top view of an example antenna design, FIG. 6C illustrates a top view of another example antenna design, FIG. 6D illustrates an expanded view of a metasurface unit cell of the structure of FIG. 6C, and FIG. 6E illustrates an expanded view of a low frequency filter of the structure of FIG. 6C. FIG. 6B shows an example of a solid metasurface 606a while FIG. 6C shows an example of a mesh metasurface 608. FIG. 6F illustrates calculated gain and S11 reflection coefficient for the antennas of FIGS. 6A-6E.

The antenna design 600 includes a substrate 604 that contains a mmWave antenna 604a disposed thereon, and a glass cover 606 (or glass substrate) separated from the substrate 604 and mmWave antenna 604a by a predetermined distance d. The substrate 604 may be supported by a mechanical support 602 and through which signals are communicated between the mmWave antenna 604a and processing circuitry. The substrate 604 and mmWave antenna 604a (as well as one or more sub-6 GHZ antennas) may be disposed within a housing 620 of a communication device that has the glass cover 606 disposed therein. Circuitry 622, including processing circuitry and the various circuitry described above, may be contained within the housing 620.

The mmWave antenna 604a may be, for example, a patch antenna that formed by deposition and etching of one or more conductive layers. The mmWave antenna 604a may have the same shape as that shown in FIG. 3A or may have a different shape. The mmWave antenna 604a may be, for example, a 1×4 patch antenna array.

The substrate 604 may be formed from a dielectric layer such as that described above. The glass cover 606, similarly, may be formed from any of the types of glass materials described above and may form a window of a smartphone or other device, for example. As shown in FIGS. 6B and 6C, multiple unit cells of the metasurface 606a may be formed on a surface of the glass cover 606 to form a modified dielectric structure. The metasurface 606a may have a periodic set of unit cells that is larger than the array of mmWave antennas 604a. The surface of the glass cover 606 on which the metasurface 606a may be formed may oppose the substrate 604 or may be further separated from the substrate 604 by the thickness of the glass cover 606. The metasurface 606a may cover (i.e., overlap in the x and y directions shown in FIGS. 3A and 3B or plane of the surface of the glass cover 606) the array of mm Wave antennas 604a as shown. In either case, a transparent protective film (not shown) such as a polyimide thin film may be disposed on the metasurface 606a. As the mmWave antenna response is substantially insensitive to the relative position between the metasurface 606a and the mm Wave antenna 604a, alignment between the metasurface 606a and the mm Wave antenna 604a may be somewhat relaxed (i.e., alignment of the antenna center with the center of the filter may be optional, allowing any design to be placed on the glass cover 606). The number of unit cells of the metasurface 606a may depend on the size and radiation pattern of the mmWave antenna 604a and the distance d.

FIG. 6B shows an expanded view of unit cell of the metasurface 608 of the structure of FIG. 6C. As can be seen, adjacent cells of the metasurface 608 may be coupled together by the filter 610 described above. The filter 610 may include a resistive portion 610a and capacitive portion 610b, which may be similar in structure to the resistive portion 506b and the parallel plate capacitor 506a described above with respect to FIG. 5C.

The various dimensions and shapes shown in FIGS. 6A-6E may be different in different aspects than that described above.

As seen in FIG. 6F, the metasurface restores the resonance frequency of the antenna, which was detuned by the glass cover.

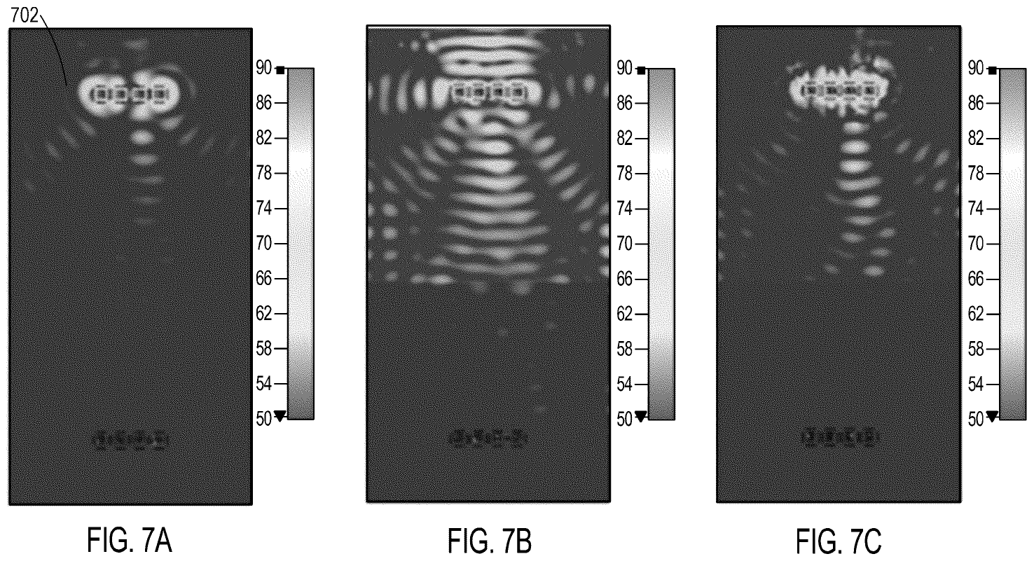

Measurements of the various examples are shown in FIGS. 7A-9D. FIG. 7A illustrates an example electric field magnitude of a 1×4 patch antenna array without a glass cover. FIG. 7B illustrates an example electric field magnitude for the 1×4 patch antenna array with a glass cover. FIG. 7C illustrates an example electric field magnitude for the 1×4 patch antenna array with a glass cover and a metasurface, with each patch antenna array being covered by a plurality of unit cells of the metasurface. The E-field magnitudes in FIGS. 7A-7C are shown in a log scale and are taken on the surface of the substrate for a 1×4 patch antenna array 702. The ground plane size is about 70× about 137.5 mm. Only a sub-6 GHz Inverted F Antenna (IFA) array (which covers lower 700-960 MHz and higher 1710 to 2170 MHz bands) is excited, while the mmWave array is terminated with 5 ohm loads. As can be seen in FIGS. 7A-7C, the metasurface has a marked effect on suppression of surface waves, specifically, the amplitude of field oscillation is suppressed by the metasurface as shown by the difference between the E-field in FIGS. 7B and 7C.

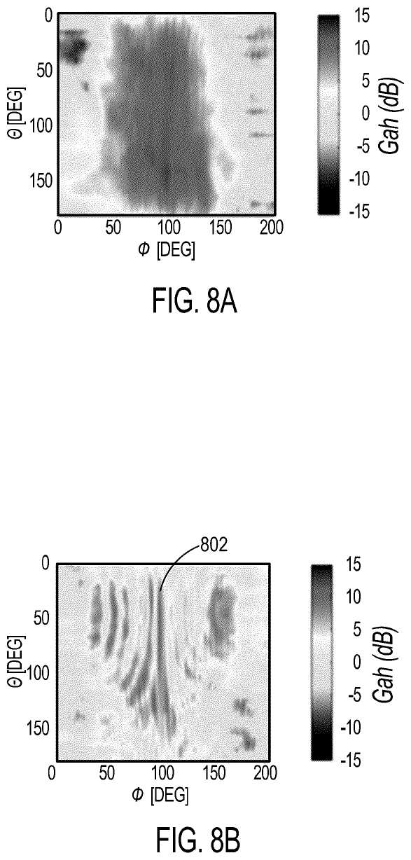

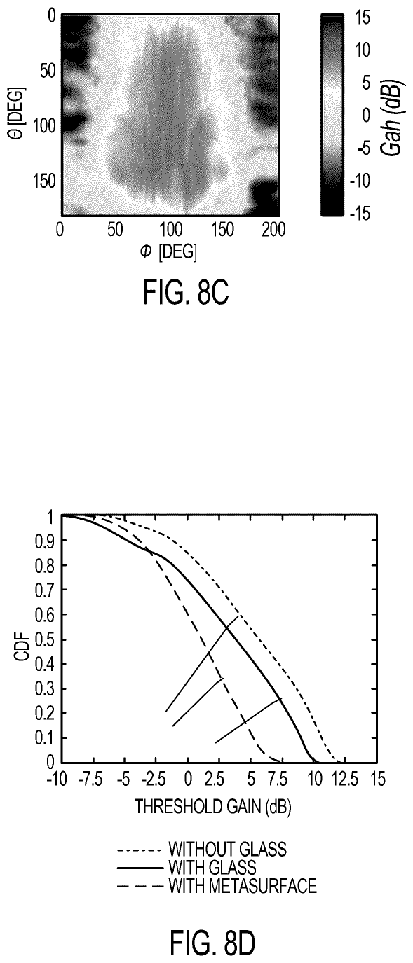

FIG. 8A illustrates an example radiation pattern without a glass cover. FIG. 8B illustrates an example radiation pattern with a glass cover. FIG. 8C illustrates an example radiation pattern with a glass cover and a metasurface. FIG. 8D illustrates an example CDF vs threshold gain. The radiation patterns are measured in the far field of the antenna—i.e., where plane waves are present (e.g., a few meters away from the antenna).

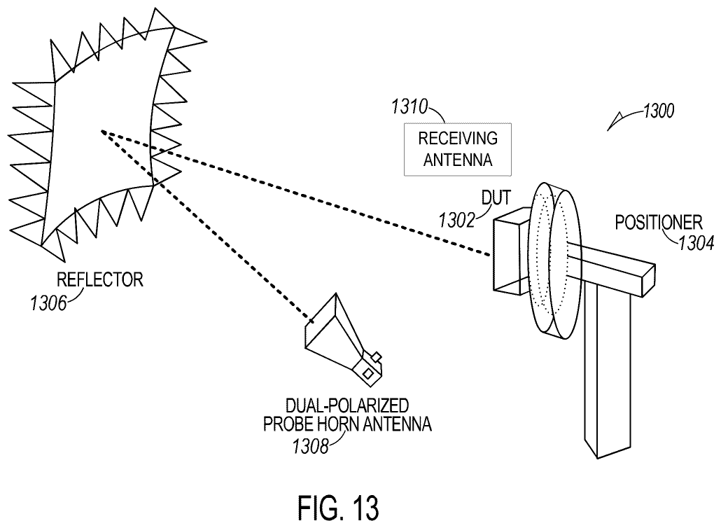

FIG. 13 is an example measurement system. The system 1300 is compact range system designed to simulate the performance of an antenna in free space without using a far-field range, including the measurements of FIGS. 8A-8D. The system 1300 includes a transmitting antenna 1308, a reflector 1306, and a receiving antenna 1310. The transmitting horn antenna 1308 radiates an electromagnetic wave that is reflected by the reflector 1306, and the receiving antenna 1310 measures the radiation pattern of the device under test (DUT) 1302, which is positioned using a positioner 1304. The DUT 1302 may be, for example, the antennas described herein. In one example, the chamber dimensions of the compact range system 1300 may be about 3× about 1.8× about 2 m with a quiet zone size of about 0.4× about 0.4 m and a frequency range of about 6 to about 60 GHz. The compact range system 1300 may mitigate the effects of the environment and minimize the effects of multipath interference, providing accurate measurements of the DUT 1302. The positioner 1304 may be able to adjust a position of the DUT 1302 mounted thereon.

As shown in FIGS. 8A and 8B, the undesired excitation of surface waves due to the presence of the glass cover causes a ripple 802 in the radiation pattern of the mmWave antenna, which is alleviated in FIG. 8C by the addition of the metasurface. As shown in FIGS. 8B, a ripple 802 may be a narrow strip in a gain pattern where a maximum gain is substantially reduced (by at least 5 dB) as compared to adjacent regions of the gain pattern on both sides of the strip and where the gain in the ripple 802 is less than 5 dB. The CDF plot in FIG. 8D shows the measured gain of a 1×4 linear array for all 4 antennas driven in-phase. Clearly, the addition of a glass cover causes a substantial distortion of the radiation pattern of the array of mm Wave patch antennas. The addition of the metasurface of FIG. 6B or 6C, largely restores the original antenna gain pattern. In some aspects, the −3 dB point shown may be chosen as the bandwidth, i.e., the antenna is radiating at half power where the gain is −3 dB lower than maximum gain. In FIG. 8C, over the interval of 50<<125, 0<<150, the gain ranges from about 4 dB to about 14 dB, i.e., a non-zero gain is present throughout the interval. Without the metasurface, as shown in FIG. 8B the same interval includes regions where the gain is 0 dB.

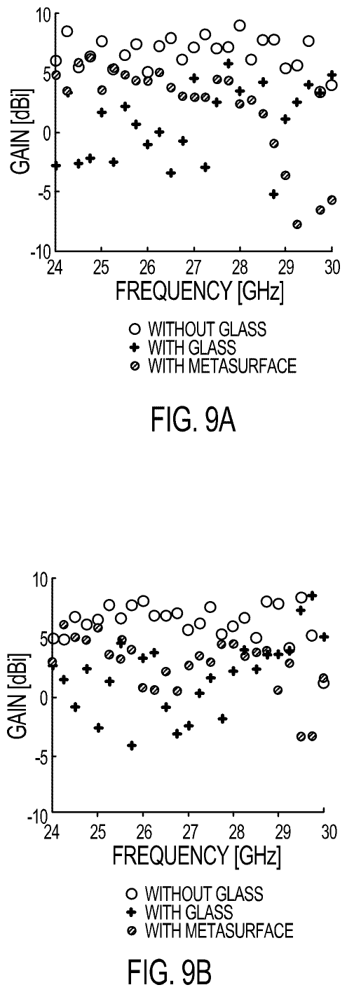

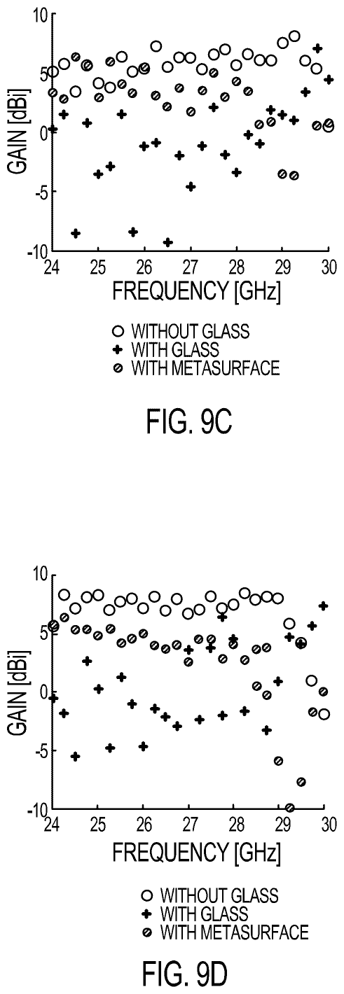

The effect of the metasurface on the performance of individual antennas of the 1×4 array is shown in FIGS. 9A-9D. FIG. 9A illustrates an example measured gain in the boresight direction for different structures for the leftmost mm Wave antenna of the array. FIG. 9B illustrates an example measured gain in the boresight direction for different structures for the mm Wave antenna next to the leftmost mm Wave antenna of the array. FIG. 9C illustrates an example measured gain in the boresight direction for different structures for the mm Wave antenna next to the rightmost mmWave antenna of the array. FIG. 9D illustrates an example measured gain in the boresight direction for different structures for the rightmost mm Wave antenna of the array. For each of the mmWave antennas of the array, the use of a metasurface as shown in the figures herein improves the antenna gain compared to only the glass cover being present at frequencies below about 27 GHZ (about 24 GHZ-27 GHz). At higher frequencies between about 27 GHz and about 30 GHz, the improvement in antenna gain is less pronounced if present.

In some aspects, the metasurface may be formed by physically (e.g., by stamping) or optically (e.g., via laser ablation) removing portions of a solid layer to form the metasurface. The metasurface may then be disposed on the glass cover prior to assembly of the glass cover in the device. Alternatively, the metasurface may be created via depositing the desired pattern (e.g., via evaporation or sputtering).

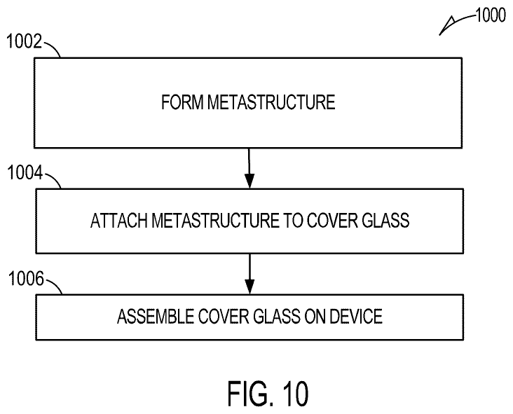

FIG. 10 is a flow diagram of an example method for providing a device that contains the metasurface. Although some operations of the method 1000 are shown in FIG. 10 additional operations may be provided, in other aspects. Alternatively, or in addition, operations may be combined in other aspects.

At operation 1002, the metasurface is formed. For example, the metasurface may be stamped out of a piece of solid metal or a lithography process used. In the latter case, a photo mask may be used to transfer the pattern onto the substrate, metal is then deposited, and the parts that are not in the mask are removed from the substrate using a chemical bath.

At operation 1004, the metasurface is attached to the glass cover. The metasurface may be attached using a thin layer of transparent adhesive or may be sealed on the glass cover using a thin protective layer, for example.

At operation 1006, the glass cover that contains the metasurface may be assembled in the device to oppose the mmWave array.

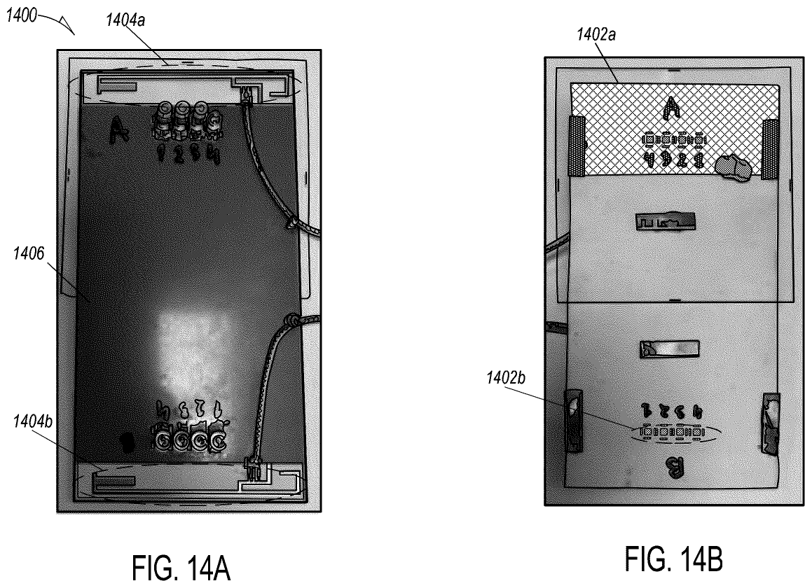

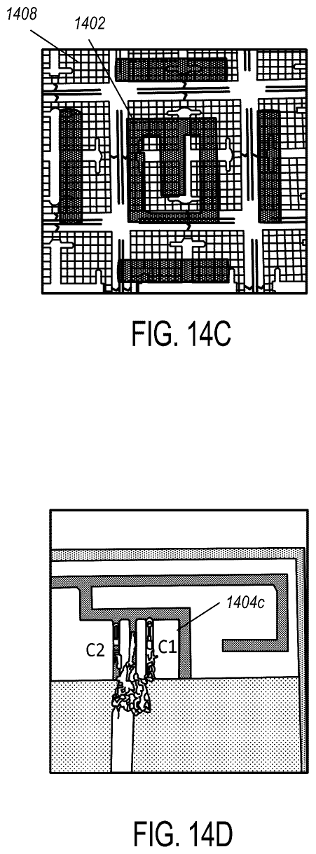

FIGS. 14A-14D show an example of a manufactured prototype antenna structure. The prototype 1400 includes an LTE antenna 1404a, 1404b and two 4-element 5G antenna arrays 1402a, 1402b. One of the antenna arrays 1402a (Array A) has a horizontally polarized element, while another of the antenna arrays 1402a, 1402b (Array B) has a vertically polarized element. The ground plane size 1406 may be about 70 mm× about 137.5 mm which is comparable to a smartphone size. The distance between the array elements of the antenna arrays 1402a, 1402b may be about 5.6 mm and the distance from the array to the substrate edge may be about 7.5 mm. In some aspects, the metasurface 1408 may be disposed parallel to the substrate (PCB) to achieve optimal performance. When the metasurface 1408 is not exactly parallel to the PCB, the array beam may be skewed and side lobes may increase. In some aspects, spacers may be used between the PCB substrate and glass superstrate. While the spacers may not affect the performance of the antenna 1402 significantly, some of the spacers may interfere with the surface waves, leading to a slight change in ripples in the radiation pattern of the antenna 1402. However, some of the spacers may interfere with the surface waves which leads to a slight change in ripples in the radiation pattern of the antenna 1402. FIG. 14C shows the metasurface 1408 on top of the elements of the antenna 1402. The metasurface 1408 is not limited to be precisely aligned with the elements of the antenna 1402, as the overall array performance was found insensitive to lateral shifts of the metasurface 1408 relative to the antenna array 1402a, 1402b. The distance between the elements of the antenna 1402 and the glass in the prototype is about 0.8 mm, somewhat higher than 0.7 mm used in the simulations. However, this difference does not strongly affect the antenna performance. An enlarged view of the feeding part of the LTE antenna 1404a, 1404b is shown in FIG. 14D, where an 11 mm clearance has been selected for the LTE IFA antenna 1404a, 1404b. The IFA antenna has two resonances between 690 MHz and 960 MHz at the low band and two resonances between 1710 MHz and 2170 MHz at the high band. Capacitors C1, C2 are connected to the antenna 1404a, 1404b at each size of the feed 1404c about 1 mm away to create a dual-band and dual-resonance performance. The left capacitor C2 from the feed 1404c is 1 pF and the right capacitor C1 is 5.6 pF. When the top LTE antenna 1404a is measured, the bottom LTE antenna 1404b is matched to 50 ohms and vice versa.

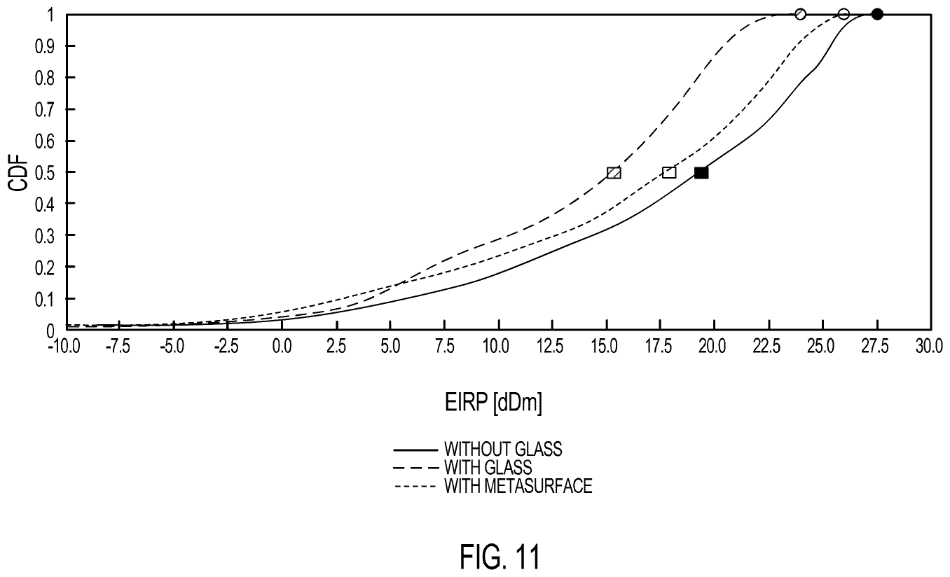

FIG. 11 is a measured coverage EIRP CDF of an example mmWave antenna. The EIRP measures power in dBm in a chosen direction. While Total Radiated Power (TRP) may be sufficient for antenna measurements at lower frequencies, the mmWave range may involve further measurements due to the complexity introduced by multiple beam-steering arrays using the mm Wave range. The CDF of EIRP represents the probability that the EIRP will not exceed a particular value, which may be relevant both for individual beams and combinations of beams. A typical 5G mm chip, after considering all losses, uses a conducted power of 15 dBm for EIRP calculations. In FIG. 11, the CDF curves are shown at 25 GHZ, with the metasurface contributing to noticeable enhancements in coverage. In FIG. 11, a gain of around 2 dB at a 0.5 spatial coverage is present, and the peak gain also rises by 2 dB compared to the absence of the metasurface. In Table I, the gain improvement is shown for different frequencies in the range from 24 to 27 GHz. As expected, the performance of the antenna array is not as wideband as for a single element. The bandwidth where improvement due to the metasurface is observed is 24-27 GHz, whereas loss instead of gain shows after 27 GHz. However, this performance comparison is based on coverage CDF only. A more comprehensive characterization, such as the total scan pattern for each frequency point, may be used to obtain a full characterization of the phased array performance.

TABLE 1
Table I. Coverage improvement

| | CDF | | |
|---|---|---|---|
| Frequency | | 0.5 | 1 |

| | | | | |
|---|---|---|---|---|
| 24 GHz | 1.5 | dB | 1.52 | dB |
| 25 GHz | 2 | dB | 2 | dB |
| 26 GHz | 1 | dB | 1 | dB |
| 27 GHz | 0 | dB | −0.5 | dB |
| 28 GHz | 0 | dB | −0.5 | dB |
| 29 GHz | 0.5 | dB | −2 | dB |

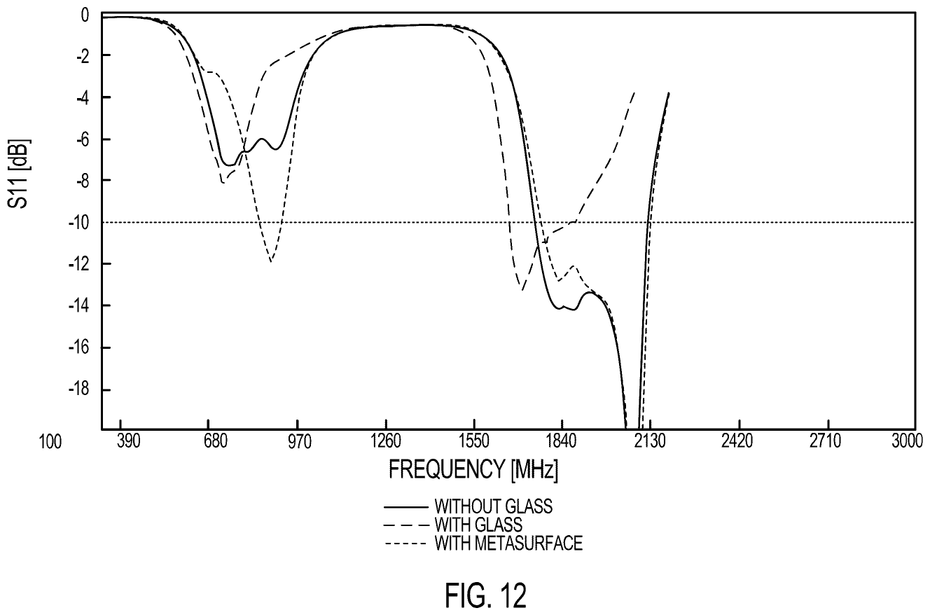

The LTE antenna in mobile terminals is also affected by the presence of glass, which can cause signal attenuation and changes in the radiation pattern. The glass material used in a mobile device, as well as the thickness and distance to the substrate, may influence the performance of the LTE antenna. Furthermore, capacitive loading of the antenna and detuning from the resonant frequency are introduced by adding a metasurface. However, by applying an appropriate metasurface design, the antenna resonance frequency may be tuned back to its original position. FIG. 12 is an example measured reflection coefficient of an LTE antenna shown in FIGS. 14A-14D. Measurements show that resonances at the 1710-2070 MHz frequency band are shifted towards their original positions, only the second resonance of the two at 690-960 MHz is returned to its original position, while the first/lower resonance is still mismatched and would use a t- or p-matching network to effectively cover the whole band.

### EXAMPLES

Various aspects described herein can be better understood by reference to the following Examples which are offered by way of illustration. The description is not limited to the Examples given herein.

Example 1 is a combined antenna structure comprising: a mmWave antenna configured to emit radiation in a mmWave band; a dielectric substrate separated from the mmWave antenna by a predetermined distance in a direction substantially perpendicular to a surface of a supporting substrate on which the mmWave antenna is disposed; and a conductive metasurface disposed on the dielectric substrate to cover the mmWave antenna in a plane substantially parallel to the surface of the supporting substrate, the metasurface comprising a substantially two-dimensional structure configured to mitigate effects of the dielectric substrate on performance of the mmWave antenna.

In Example 2, the subject matter of Example 1 includes that the dielectric substrate comprises glass.

In Example 3, the subject matter of Examples 1-2 includes that the metasurface is at least one of relatively thin or has a relatively small area compared to the dielectric substrate.

In Example 4, the subject matter of Examples 1-3 includes that the metasurface comprises periodic unit cells each having a main area with a cutout disposed therein.

In Example 5, the subject matter of Example 4 includes that adjacent unit cells are coupled together by a filter having a sub-6 GHz passband.

In Example 6, the subject matter of Example 5 includes that the filter is a planar filter that comprises: a resistive portion formed by windings coupled to the main areas of the adjacent unit cells, and a capacitive portion formed by a parallel plate capacitor disposed between the windings.

In Example 7, the subject matter of Examples 4-6 includes that the main area is formed from a solid conductor.

In Example 8, the subject matter of Examples 4-7 includes that the main area is formed by a mesh.

In Example 9, the subject matter of Examples 4-8 includes that multiple unit cells cover the mm Wave antenna.

In Example 10, the subject matter of Examples 1-9 includes that the cutout forms a plus sign whose legs end in a cross.

In Example 11, the subject matter of Examples 1-10 includes that the metasurface is formed on a surface of the dielectric substrate opposing the mmWave antenna.

In Example 12, the subject matter of Examples 1-11 includes that the metasurface is formed on a surface of the dielectric substrate parallel with a surface of the dielectric substrate opposing the mmWave antenna.

In Example 13, the subject matter of Examples 1-12 includes that the performance of the mmWave antenna includes electric field, radiation pattern, and antenna gain.

Example 14 is a modified dielectric structure comprising: a glass substrate; and a conductive metasurface disposed on the glass substrate, the metasurface comprising a substantially two-dimensional structure configured to mitigate effects of the glass substrate on radiation from a mmWave antenna.

In Example 15, the subject matter of Example 14 includes that the metasurface comprises periodic unit cells each having a main area with a cutout disposed therein.

In Example 16, the subject matter of Example 15 includes that adjacent unit cells are coupled together by a planar filter having a sub-6 GHz passband, the planar filter comprising: a resistive portion formed by windings coupled to the main areas of the adjacent unit cells, and a capacitive portion formed by a parallel plate capacitor disposed between the windings.

In Example 17, the subject matter of Examples 15-16 includes that the main area is formed from a solid conductor.

In Example 18, the subject matter of Examples 15-17 includes that the main area is formed by a mesh.

Example 19 is a communication device comprising: a housing in which is disposed: a sub-6 GHz antenna configured to emit radiation in a sub-6 GHz band; a dielectric substrate on which a mmWave patch antenna configured to emit radiation in a mmWave band is disposed; and a processor configured control communications using the sub-6 GHz antenna and the mm Wave patch antenna; a glass cover surrounded by the housing and separated from the dielectric substrate by a predetermined distance in a direction substantially perpendicular to a surface of the dielectric substrate on which the mmWave patch antenna is disposed; and a conductive metasurface disposed on the glass cover to cover the mmWave patch antenna in a plane substantially parallel to the surface of the supporting substrate, the metasurface comprising a substantially two-dimensional structure configured to mitigate effects of the glass cover on performance of the mmWave patch antenna.

In Example 20, the subject matter of Example 19 includes that the metasurface comprises periodic unit cells each having a main area with a cutout disposed therein, adjacent unit cells are coupled together by a filter having a sub-6 GHz passband.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20. Exemplary Aspects.

The following exemplary aspects are provided, the numbering of which is not to be construed as designating levels of importance:

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A combined antenna structure comprising:
a mmWave antenna configured to emit radiation in a mmWave band;
a dielectric substrate separated from the mmWave antenna by a predetermined distance in a direction substantially perpendicular to a surface of a supporting substrate on which the mmWave antenna is disposed; and
a conductive metasurface disposed on the dielectric substrate to cover the mmWave antenna in a plane substantially parallel to the surface of the supporting substrate, the metasurface comprising a substantially two-dimensional structure configured to mitigate effects of the dielectric substrate on a gain pattern of the mmWave antenna.

2. The combined antenna structure of claim 1, wherein the dielectric substrate comprises glass.

3. The combined antenna structure of claim 1, wherein the metasurface comprises periodic unit cells each having a main area with a cutout disposed therein.

4. The combined antenna structure of claim 3, wherein the cutout forms a plus sign whose legs end in a cross.

5. The combined antenna structure of claim 3, wherein adjacent unit cells are coupled together by a filter having a sub-6 GHz passband.

6. The combined antenna structure of claim 5, wherein the filter is a planar filter that comprises:
a resistive portion formed by windings coupled to main areas of the adjacent unit cells, and
a capacitive portion formed by a parallel plate capacitor disposed between the windings.

7. The combined antenna structure of claim 3, wherein the main area is formed from a solid conductor.

8. The combined antenna structure of claim 3, wherein the main area is formed by a mesh.

9. The combined antenna structure of claim 3, wherein multiple unit cells cover the mmWave antenna.

10. The combined antenna structure of claim 1, wherein the metasurface is formed on a surface of the dielectric substrate opposing the mmWave antenna.

11. The combined antenna structure of claim 1, wherein the metasurface is formed on a surface of the dielectric substrate parallel with a surface of the dielectric substrate opposing the mmWave antenna.

12. The combined antenna structure of claim 1, wherein, at an opposing surface of the dielectric substrate, a far-field gain pattern comprises no ripples over a spherical sector covering a range of azimuthal angles from 50° to 125°.

13. The combined antenna structure of claim 1, further comprising another antenna configured to operate at sub-6 GHz frequencies, the conductive metasurface configured to not interfere with operation of the other antenna.

14. A modified dielectric structure comprising:
a glass substrate; and
a conductive metasurface disposed on the glass substrate, the metasurface comprising a substantially two-dimensional structure configured to mitigate effects of the glass substrate on a gain pattern of a mmWave antenna.

15. The modified dielectric structure of claim 14, wherein the metasurface comprises periodic unit cells each having a main area with a cutout disposed therein.

16. The modified dielectric structure of claim 15, wherein adjacent unit cells are coupled together by a planar filter having a sub-6 GHz passband, the planar filter comprising:
a resistive portion formed by windings coupled to main areas of the adjacent unit cells, and
a capacitive portion formed by a parallel plate capacitor disposed between the windings.

17. The modified dielectric structure of claim 15, wherein the main area is formed from a solid conductor.

18. The modified dielectric structure of claim 15, wherein the main area is formed by a mesh.

19. A communication device comprising:
a housing in which is disposed:
a sub-6 GHz antenna configured to emit radiation in a sub-6 GHz band;
a dielectric substrate on which a mmWave patch antenna configured to emit radiation in a mmWave band is disposed; and
a processor configured control communications using the sub-6 GHz antenna and the mmWave patch antenna;
a glass cover surrounded by the housing and separated from the dielectric substrate by a predetermined distance in a direction substantially perpendicular to a surface of the dielectric substrate on which the mmWave patch antenna is disposed; and
a conductive metasurface disposed on the glass cover to cover the mmWave patch antenna in a plane substantially parallel to the surface of the dielectric substrate, the metasurface comprising a substantially two-dimensional structure configured to mitigate effects of the glass cover on a gain pattern of the mmWave patch antenna.

20. The communication device of claim 19, wherein the metasurface comprises periodic unit cells each having a main area with a cutout disposed therein, adjacent unit cells are coupled together by a filter having a sub-6 GHz passband.
